(19) United States
(12) Patent Application Publication
(10) Pub. No.: US 2009/0048019 A1
(43) Pub. Date: Feb. 19, 2009

(54) GAME PROGRAM, GAME APPARATUS, AND GAME CONTROL METHOD

(75) Inventors: Hideki NAGAHAMA, Takasago (JP); Atsunori SAKAMOTO, Osaka (JP); Kosaku KOSHIYAMA, Osaka (JP)

Correspondence Address: GLOBAL IP COUNSELORS, LLP, 1233 20TH STREET, NW, SUITE 700, WASHINGTON, DC, 20036-2680, US

(73) Assignee: Konami Digital Entertainment Co., Ltd, Tokyo (JP)

(21) Appl. No.: 12/256,061

(22) Filed: Oct. 22, 2008

Related U.S. Application Data
(63) Continuation of application No. PCT/JP2007/059664, filed on May 10, 2007.

(30) Foreign Application Priority Data
May 24, 2006 (JP) 2006-143977

(51) Int. Cl. G06F 17/00

(52) U.S. Cl. 463/34

(57) ABSTRACT

In this game program, a character and a moving object when the game space is viewed from a first direction is displayed on an image display unit in the position of the character and the position of the moving object recognized by a control unit. Then, whether or not the moving direction of the moving object has changed due to a movement of the character displayed on the image display unit is judged by the control unit. If the control unit judged that the moving direction of the moving object has changed due to a movement of the character, a character near the path of the moving object determined by the changed moving direction of the moving object is recognized by the control unit as the first object character. Then, information corresponding to the first object character is displayed on the image display unit.

### CROSS-REFERENCE TO THE RELATED APPLICATIONS

This application claims priority to Japanese Patent Application Nos. 2006-341292 and 2006-341293. The entire disclosure of Japanese Patent Application Nos. 2006-341292 and 2006-341293 is hereby incorporated herein by reference.

### BACKGROUND OF THE INVENTION

1. Field of the Invention

The present invention relates to a game program, and in particular, a game program for implementing a game in which characters and a moving object are displayed on an image display unit, in a computer. In addition, the present invention relates to a game apparatus that is able to execute a game implemented by this game program, and a video game control method able to control a game implemented by this game program through a computer.

2. Description of the Related Art

Various video games have conventionally been proposed. These video games are executed in game apparatuses. For example, a general game apparatus includes a monitor, a game machine main body that is separate from the monitor, and an input unit, for example a controller that is separate from the game machine main body. A plurality of input buttons is arranged on the controller. In this kind of a game apparatus, a character displayed on the monitor can be manipulated by operating the input buttons.

A competing game, for instance, a baseball game is one of the games executed in this kind of a game apparatus. Non-patent document 1: Live Powerful Pro Baseball 12, Konami Corporation, PS2 version, Jul. 14, 2005, discloses such competing game, as an example. In this baseball game, a player can give out various instructions to the pitcher character, fielder characters, and batter character by operating the controller. For instance, if the player manipulates a character on the fielding side, at first, on a batting screen, a pitcher character and a fielder character are displayed on the monitor. Then, if a pitching instruction is given to the pitcher character, the ball released from the pitcher character is displayed on the monitor. And, if the opponent player gives out a swing instruction to the batter character, the state that the batter character is performing a swing movement is displayed on the monitor. If the ball is hit back by the swing movement of the batter character, on the batting screen, the ball that is hit back is displayed on the monitor. Then, the screen is switched from the batting screen to a fielding screen, and on the fielding screen, the ball hit back by the batter character and the fielder character are displayed. At this time, a triangular symbol is displayed above the fielder character positioned in the moving direction of the ball that is hit back by the batter character. In this state, if the player operates the cross-shape buttons of the controller, the state that the fielder character displayed below the triangular symbol moving in the direction of the cross-shape button operated is displayed on the monitor. Then, if the fielder character can be moved close to the ball that is hit back, the state that the fielder character catches the ball is displayed on the monitor. In other words, it is possible to have the fielder character catch the ball.

In a conventional baseball game, the screen is switched from the batting screen to the fielding screen after the ball hit back by the batter character is displayed on the monitor. The fielder character is being moved to the direction of the ball that is hit back, through the cross-shape buttons of the controller being operated on the fielding screen. However, despite a fact that there is very little time from when the ball is hit back by the batter character until the ball hit back moves near the fielder character, after the screen is switched from the batting screen to the fielding screen, on the fielding screen, a player makes a judgment on the selection of a fielder character that is the object to be operated from the plurality of fielder characters, and the player had to instruct a movement command on the selected fielder character. For this reason, there existed a problem that the player may incorrectly select a fielder character to be the object to be operated, and may make a mistake on the moving direction that is instructed to the fielder character. For instance, in a conventional baseball game, on the batting screen, if the ball is hit back in the direction to a gap between a shortstop character and a third baseman character by the batter character, on the batting screen, it is difficult for the player to judge whether the fielder character, the object to be operated, should be the third baseman character or the shortstop character. In this state, on the screen switched from the batting screen to the fielding screen, the player has to determine to select either the shortstop character or the third baseman character, and has to instruct a movement command to the selected character. For this reason, even though the player may wish to select the third baseman character, there existed the problem that the player may mistakenly select the shortstop character, and may make a mistake on the moving direction that is instructed to the selected character.

### SUMMARY OF THE INVENTION

It is an object of the present invention to allow the player to be able to quickly execute a command on a character.

The game program according to a first aspect is a program for implementing the following functions on a computer that is capable of executing a game in which characters and a moving object are displayed on an image display unit.

(1) A game space recognition function by which a game space is recognized by a control unit.

(2) A character position recognition function by which the positions of the plurality of characters arranged in the game space are recognized by the control unit.

(3) A moving object position recognition function by which the position of the moving object that moves in the game space is recognized by the control unit.

(4) A first object display function for displaying the moving object and at least any of one of the plurality of characters when the game space is viewed from a first direction (from a first view point) in the position of the moving object and positions of the characters recognized by the control unit on the image display unit.

(5) A moving direction determination function by which whether or not the moving direction of the moving object has changed due to a movement of the character displayed on the image display unit is judged by the control unit.

(6) A first object character recognition function by which the character near the path (trajectory) of the moving object determined by the changed moving direction of the moving object is recognized by the control unit as the first object character, if the control unit judged that the moving direction of the moving object has changed due to a movement of the character.

(7) A first object character information display function for displaying information corresponding to the first object character on the image display unit.

With this game program, in the game space recognition function, the game space is recognized by the control unit. In the character position recognition function, the positions of the plurality of characters arranged in the game space are recognized by the control unit. In the moving object position recognition function, the position of the moving object that moves in the game space is recognized by the control unit. In the first object display function, the moving object and at least any of one of the plurality of characters when the game space is viewed from a first direction are displayed in the position of the moving object and the positions of the characters recognized by the control unit on the image display unit. In the moving direction determination function, whether or not the moving direction of the moving object has changed due to a movement of the character displayed on the image display unit is judged by the control unit. In the first object character recognition function, if the control unit judged that the moving direction of the moving object has changed due to a movement of the character, the character near the path of the moving object determined by the changed moving direction of the moving object is recognized by the control unit as the first object character. In the first object character information display function, information corresponding to the first object character is displayed on the image display unit.

For instance, if a baseball game is implemented by this game program, a game space for executing the baseball game is recognized by a control unit. Then, positions of a plurality of characters including a pitcher character, batter character, fielder characters, and catcher character and other characters arranged in this game space are recognized by the control unit. The position of the ball character that moves in the game space is recognized by the control unit. For instance, the position of the ball character released from the pitcher character, position of the ball character hit back by the batter character, and the like are recognized by the control unit. Then, the pitcher character, batter character, fielder characters, and ball character released from the pitcher character when the game space is viewed from the direction of the catcher character are displayed on the image display unit in the positions of the position of each character recognized by the control unit. In this state, whether or not the moving direction of the ball character has changed due to a movement of the batter character displayed on the image display unit is judged by the control unit. For instance, whether or not the ball character is hit back according to a swing movement of the batter character is judged by the control unit. Then, if the control unit judged that the ball character is hit back according to a swing movement of the batter character, the fielder character near the path of the ball character that is hit back is recognized by the control unit as the first object character. And, information corresponding to the first object character is displayed on the image display unit.

In this case, in the state that the pitcher character, batter character, fielder characters, and ball character released from the pitcher character when the viewed from the direction of the catcher character are displayed on the image display unit, for instance on the batting screen, if the control unit judged that the ball character is hit back according to the swing movement of the batter character, information corresponding to the first object character near the path of the ball character that is hit back, for instance player name, number on the back of the player, fielding position, and the like is displayed on the image display unit. By doing so, on the batting screen before switching to the fielding screen, the player is able to see information corresponding to the first object character that is near the path of the ball character that is hit back, on the image display unit. For this reason, the first object character near the path of the ball character that is hit back, e.g., the character to be the object to be operated can be determined on the batting screen based on the information corresponding to the character of the object to be operated, and the next operation can be executed quickly. In other words, determining about the catch of the ball character hit back by the batter character can begin from the stage of the batting screen. For this reason, the player will be able to quickly execute a command on a character.

The game program according to a second aspect is the game program according to the first aspect, and is a program for further implementing the following functions on the computer.

(8) An elapse time determination function by which whether or not a predetermined time has passed from the time that the control unit judged that the moving direction of the moving object has changed due to a movement of the character is judged by the control unit.

(9) A second object display function for displaying the moving object and at least any of one of the plurality of characters when the game space is viewed from a second direction (from a second view point) in the position of the moving object and positions of the characters recognized by the control unit on the image display unit, if the control unit judged that the predetermined time has passed.

With this game program, in the elapse time determination function, whether or not a predetermined time has passed form the time that the control unit judged that the moving direction of the moving object has changed due to a movement of the character is judged by the control unit. In the second object display function, if the control unit judged that a predetermined time has passed from the time that the control unit judged that the moving direction of the moving object has changed due to a movement of the character, the moving object and at least any of one of the plurality of characters when the game space is viewed from a second direction are displayed on the image display unit in the position of the moving object and the positions of the characters recognized by the control unit.

For instance, if a baseball game is implemented by this game program, whether or not a predetermined time has passed from the time that the control unit judged that the ball character is hit back due to the swing movement of the batter character is judged by the control unit. Then, if the control unit judged that a predetermined time has passed from the time that the control unit judged that the ball character is hit back due to the swing movement of the batter character, the pitcher character, batter character, catcher character, fielder characters, and ball character hit back by the batter character when the game space is viewed from up in the air are displayed on the image display unit in positions of the position of each character recognized by the control unit.

In this case, if the control unit judged that a predetermined time has passed from the time that the control unit judged that the ball character is hit back, each of the characters when the game space is viewed from up in the air is displayed on the image display unit in the positions of the position of each character recognized by the control unit. In this manner, when the screen is switched from the state that each character when viewed from the direction of the catcher character is displayed on the image display unit, e.g., batting screen to the state that each character when the game space is looked down from above is displayed on the image display unit, e.g., fielding screen, since the player is able to judge beforehand on the batting screen about the first object character, e.g., the fielder character to be the object to be operated based on the information corresponding to the character that is the object to be operated, the player is able to quickly instruct a command on the character that is the object of operation on the fielding screen. In other words, the player will be able to quickly execute a command on a character.

The game program according to a third aspect is the game program according to the second aspect, wherein the moving object is displayed on the image display unit in the position of the moving object recognized by the control unit when the control unit judged that the moving direction of the moving object has changed. This function is realized in the second object display function.

In this case, for instance, the ball character is displayed on the image display unit in the position of the ball character recognized by the control unit when the control unit judged that the moving direction of the ball character has changed. Specifically, when the screen is switched from the batting screen to the fielding screen, the ball character is displayed in the position of the ball character when the ball character is hit back by the batter character. In other words, at the point of time that the screen is switched to the fielding screen, the displaying of the ball character starts in a state that the time is slightly returned backwards. For this reason, even if the screen is switched to the fielding screen after a predetermined time has passed during the batting screen, since the ball character is displayed in a position of the ball character when the ball character is hit back by the batter character, on the fielding screen, the time for the player to instruct a command on the character of the object of operation can be secured to be comparatively longer. By doing so, even for a player who is a beginner and not used to the game, a character can be manipulated comparatively easily. In addition, the above described “when the control unit judged that the moving direction of the ball character has changed” includes the moment that the ball character is hit back by the bat, and includes until the state that the ball character flew slightly out toward the front side.

The game program according to a fourth aspect is the game program according to any of the first to the third aspects, and is a program for further implementing the following functions on the computer.

(10) A second object character recognition function by which the character that is different from the first object character is recognized by the control unit as the second object character based on an input signal from an input unit.

(11) A second object character information display function for displaying information corresponding to the second object character on the image display unit.

In this game program, in the second object character recognition function, a character different from the first object character is recognized by the control unit as the second object character based on an input signal from the input unit. In the second object character information display function, information corresponding to the second object character is displayed on the image display unit.

For instance, if a baseball game is implemented by this game program, if the player operates an input button of the input unit, e.g., a cross-shape button, based on the input signal from the input unit, a character that is different from the first object character, e.g., a character in the operation direction of the cross-shape button is recognized by the control unit as the second object character. Then, information corresponding to this second object character is displayed on the image display unit.

In this case, the second object character is recognized by the control unit through the operation of the input unit, e.g., cross-shape buttons by the player, and information corresponding to the second object character is displayed on the image display unit. In other words, through the operation of the cross-shape buttons for selecting the second object character in a position different from the first object character, information on the second object character is displayed on the screen. By doing so, information corresponding to any character, in other words, the second object character, selected by the player can be seen on the image display unit. As a result, in the stage that the offense screen is displayed, the fielding character (second object character) at the moment that the screen is switched to the subsequent fielding screen can be clearly recognized by the player beforehand. For this reason, the second object character, e.g., character to be the object of operation that is selected by the player can be determined based on the information corresponding to the character of the object of operation, and it is possible to quickly execute the next operation. In other words, the player will be able to quickly execute a command on a character.

The game program according to a fifth aspect is the game program according to any of the second to the fourth aspects, and is a program for further implementing the following function on the computer.

(12) An information non-display command issuing function by which a command for hiding the information displayed on the image display unit is issued by the control unit if the control unit judged that the predetermined time has passed from the time that the control unit judged that the moving direction of the moving object has changed due to a movement of the character.

In this game program, in the information non-display command issuing function, if the control unit judged that a predetermined time has passed from the time that the control unit judged that the moving direction of the moving object has changed due to a movement of the character, a command for hiding the information displayed on the image display unit is issued from the control unit.

For instance, if a baseball game is implemented by this game program, if the control unit judged that a predetermined time has passed from the time that the control unit judged that the ball character is hit back according to a swing movement of the batter character, a command for hiding the information displayed on the image display unit is issued from the control unit. In other words, when the screen is switched from the batting screen to the fielding screen, the information displayed on the image display unit will not be displayed on the image display unit. For this reason, in the state that the information corresponding to the character of the object of operation is visible to the player on the batting screen, when the screen is switched from the batting screen to the fielding screen, it is possible to directly make the player pay attention to the character of the object of operation, and the player will be able to quickly execute a command on the character.

The game program according to a sixth aspect is the game program according to any of the first to the fifth aspects, and is a program for further implementing the following function on the computer.

(13) A first indicator display function for displaying on the image display unit an indicator for informing about the first object character.

In this game program, in the first indicator display function, an indicator for informing about the first object character is displayed on the image display unit.

In this case, an indicator for informing about the first object character, for instance a triangular symbol for pointing at the first object character is displayed above the first object character. By doing so, the player will be able to instantly see the character (first object character) near the path of the ball character that is hit back, and the player will be able to quickly execute a command on the character.

The game program according to a seventh aspect is the game program according to any of the first to the sixth aspects, and is a program for further implementing the following functions on the computer.

(14) A second object character recognition function by which the character that is different from the first object character is recognized by the control unit as the second object character based on an input signal from the input unit.

(15) A second indicator display function for displaying on the image display unit an indicator for informing about the second object character.

In this game program, in the second object character recognition function, based on the input signal from the input unit, a character different from the first object character is recognized by the control unit as the second object character. In the second indicator display function, an indicator for informing about the second object character is displayed on the image display unit.

In this case, the indicator for informing about the second object character, for instance a triangular symbol for pointing at the second object character is displayed above the second object character. By doing so, the player will be able to instantly see the second object character that is selected by the player, and the player will be able to quickly execute a command on the character.

The game program according to an eighth aspect is the game program according to any of the first to the seventh aspects, wherein the information corresponding to the character includes a first term for differentiating the plurality of characters from each other, and a second term for differentiating the roles of each of the plurality of characters.

In this case, the information corresponding to the character includes a first term, e.g., player name and the number on the back, and a second term, e.g., fielding position. For this reason, it becomes easy to determine on the image display unit the information corresponding to the first object character that is near the path of the ball character that is hit back, and the information corresponding to the second object character that is selected by the player, and the player will be able to execute even more quickly a command on the target character.

The game apparatus according to a ninth aspect is a game apparatus that is capable of executing a game in which characters and a moving object are displayed on an image display unit. This game apparatus includes a game space recognition means by which a game space is recognized by a control unit; a character position recognition means by which positions of the plurality of characters arranged in the game space are recognized by the control unit; a moving object position recognition means by which the position of the moving object that moves in the game space is recognized by the control unit; a first object display means for displaying the moving object and at least any of one of the plurality of characters when the game space is viewed from a first direction in the position of the moving object and positions of the characters recognized by the control unit on the image display unit; a moving direction determination means by which whether or not the moving direction of the moving object has changed due to a movement of the character displayed on the image display unit is judged by the control unit; a first object character recognition means by which the character near the path of the moving object determined by the changed moving direction of the moving object is recognized by the control unit as the first object character, if the control unit judged that the moving direction of the moving object has changed due to a movement of the character; and a first object character information display means for displaying information corresponding to the first object character on the image display unit.

The game control method according to a tenth aspect is a game control method that is able to control a game in which characters and a moving object are displayed on an image display unit through a computer. This game control method includes a game space recognition step in which a game space is recognized by a control unit, a character position recognition step in which positions of the plurality of characters arranged in the game space are recognized by the control unit, a moving object position recognition step in which the position of the moving object that moves in the game space is recognized by the control unit, a first object display step in which the moving object and at least any of one of the plurality of characters when the game space is viewed from a first direction are displayed in the position of the moving object and positions of the characters recognized by the control unit on the image display unit, a moving direction determination step in which whether or not the moving direction of the moving object has changed due to a movement of the character displayed on the image display unit is judged by the control unit, a first object character recognition step in which the character near the path of the moving object determined by the changed moving direction of the moving object is recognized by the control unit as the first object character if the control unit judged that the moving direction of the moving object has changed due to a movement of the character, and a first object character information display step in which information corresponding to the first object character is displayed on the image display unit.

### BRIEF DESCRIPTION OF THE DRAWINGS

Referring now to the attached drawings which form a part of this original disclosure:

FIG. 1 is a diagram of a video game apparatus according to an embodiment of the present invention;

FIG. 2 is a function block diagram of the game apparatus;

FIG. 3 is a batting screen of an initial state;

FIG. 4 is a batting screen showing when the batter is manipulated;

FIG. 5 is a batting screen in which information corresponding to a first object character is displayed;

FIG. 6 is a fielding screen that is immediately after the screen is switched from a batting screen;

FIG. 7 is a fielding screen showing when selecting a second object character;

FIG. 8 is a flowchart (1) on a selection player preliminarily informing system;

FIG. 9 is a flowchart (2) on a selection player preliminarily informing system; and

FIG. 10 is a diagram for describing a calculating method of a path.

### BRIEF DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### Configuration and Operation of the Game Apparatus

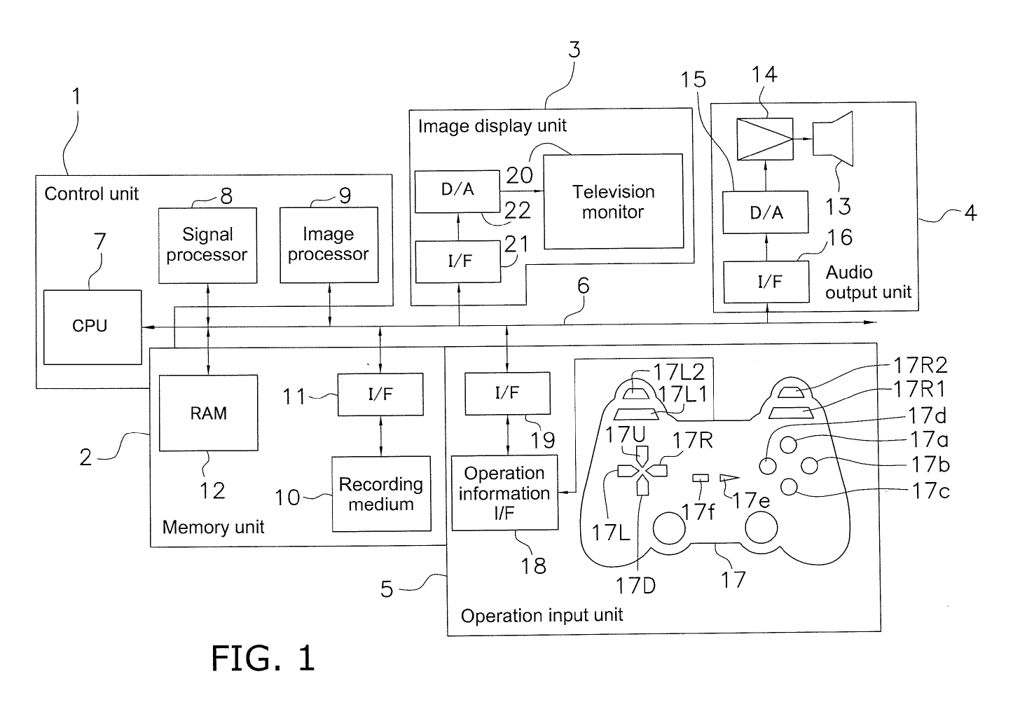

FIG. 1 shows the basic configuration of a game apparatus in accordance with an embodiment of the present invention. Here, a home video game apparatus will be described as an example of a video game apparatus. The home video game apparatus is provided with a home game machine main body and a home television. A recording medium 10 can be mounted in the home game machine main body, and game data is read as needed from the recording medium 10 and the game is executed. In this manner, the executed game content is displayed on the home television.

A game system of a home video game apparatus is composed of a control unit 1, a memory unit 2, an image display unit 3, an audio output unit 4, and an operation input unit 5, and each of these are connected via a bus 6. The bus 6 includes an address bus, a data bus, a control bus, and the like. Here, the control unit 1, the memory unit 2, the audio output unit 4, and the operation input unit 5 are contained in the home game machine main body of the home video game apparatus, and the image display unit 3 is contained in the home television.

The control unit 1 is mainly provided for controlling, based on a game program, the progress of the entire game. The control unit 1 is composed of, for instance, a CPU (Central Processing Unit) 7, a signal processor 8, and an image processor 9. The CPU 7, the signal processor 8, and the image processor 9 are mutually connected through the bus 6. The CPU 7 interprets commands from the game program, performs various data processing and various kinds of controls. For example, the CPU 7 commands the signal processor 8 to feed image data to the image processor. The signal processor 8 primarily performs calculations in a 3D space, calculations for converting positions from the 3D space to a virtual 3D space, light source calculation process, and image and audio data generation and processing process based on the calculation result executed in the 3D space or the virtual 3D space. Based on the calculation results and processing results of the signal processor 8, the image processor 9 primarily performs a process in which image data to be visualized is written to a RAM 12. In addition, the CPU 7 commands the signal processor 8 to process various data. The signal processor 8 primarily performs calculations corresponding to various data in 3D space, and calculations for converting positions from 3D space to a virtual 3D space.

The memory unit 2 is provided primarily for storing program data and various data used by the program data, and other data. The memory unit 2 is, for instance, composed of a recording medium 10, an interface circuit 11, and a RAM (Random Access Memory) 12. The interface circuit 11 is connected to the recording medium 10. The interface circuit 11 and the RAM 12 are connected through the bus 6. The recording medium 10 is a medium for recording the program data of the operation system; game data composed of image data, audio data, and various program data; and other data. The recording medium 10 is, for instance, a ROM (Read Only Memory) cassette, optical disk, flexible disk, or the like, and the program data of the operating system, the game data, and other data are recorded on the recording medium 10. In addition, the recording medium 10 also includes a card memory, and the card memory is primarily used for saving various game parameters at breakpoints when the game has been suspended. The RAM 12 is used for temporarily storing various data that are read from the recording medium 10, and for temporarily recording a processing result from the control unit 1. Stored in the RAM 12 are various data as well as address data that shows the recording position of various data, and any address can be specified and address data can be read from or written to the specified address.

The image display unit 3 is provided primarily for outputting the image data written into the RAM 12 by the image processor 9, the image data that is read from the recording medium 10, and the like, as images. The image display unit 3 is composed of for instance, a television monitor 20, an interface circuit 21, and a D/A converter (Digital-to-Analog converter) 22. The D/A converter 22 is connected to the television monitor 20, and the interface circuit 21 is connected to the D/A converter 22. The bus 6 is connected to the interface circuit 21. In this case, image data is fed to the D/A converter 22 through the interface circuit 21, and converted at this point into an analog image signal. The analog image signal is then outputted as an image to the television monitor 20.

Examples of image data here include polygon data and texture data. The polygon data is coordinate data of the apices constituting a polygon. The texture data is data for setting the texture of a polygon, and is composed of texture instruction data and texture color data. The texture instruction data is data for correlating the polygon and texture, and the texture color data is data for specifying the color of a texture. In this case, polygon address data and texture address data showing the memory position of each of the data are correlated with the polygon data and texture data. With such image data, the polygon data (3D polygon data) in a 3D space defined by the polygon address data is subjected by the signal processor 8 to coordinate transformation and perspective projection transformation on the basis of rotation variable data and movement variable data of the screen as such (point of view), and the result is substituted into polygon data in a 2D space (2D polygon data). The plurality of 2D polygon data composes a polygon outline, and the texture data indicated by the texture address data is written into the internal areas of the polygon. Objects, i.e., various characters, can thus be expressed on which texture is overlaid on each of the polygons.

The audio output unit 4 is provided primarily for outputting audio data read out from the recording medium 10 as audio output. The audio output unit 4 is composed of, e.g., a speaker 13, an amplifier circuit 14, a D/A converter 15, and an interface circuit 16. The amplifier circuit 14 is connected to the speaker 13, the D/A converter 15 is connected to the amplifier circuit 14, and the interface circuit 16 is connected to the D/A converter 15. The bus 6 is connected to the interface circuit 16. In this configuration, audio data is fed to the D/A converter 15 through the interface circuit 16 and is converted at this point to an analog audio signal. The analog audio signal is amplified by the amplifier circuit 14 and is outputted as audio from the speaker 13. Examples of audio data include ADPCM (Adaptive Differential Pulse Code Modulation) data and PCM (Pulse Code Modulation) data. In the case of ADPCM data, audio can be outputted from the speaker 13 by using the same processing method as that described above. In the case of PCM data, PCM data is converted to ADPCM data in the RAM 12, by which audio can be outputted from the speaker 13 by using the same processing method as that described above.

The operation input unit 5 is primarily composed of a controller 17, an operation information interface circuit 18, and an interface circuit 19. The operation information interface circuit 18 is connected to the controller 17, and the interface circuit 19 is connected to the operation information interface circuit 18. The bus 6 is connected to the interface circuit 19.

The controller 17 is an operating device that the player uses to input various operation commands, and transmits to the CPU 7 operation signals that correspond with the operation performed by the player. The controller 17 is provided with a first button 17a, a second button 17b, a third button 17c, a fourth button 17d, an up-direction key 17U, a down-direction key 17D, a left-direction key 17L, a right-direction key 17R, an L1 button L1, an L2 button L2, an R1 button 17R1, an R2 button 17R2, a start button 17e, a select button 17f, a left stick 17SL, and a right stick 17SR.

The up-direction key 17U, down-direction key 17D, left-direction key 17L, and right-direction key 17R are used for, e.g., giving commands to the CPU 7 to move a character or cursor up, down, left, or right on the screen of the television monitor 20.

The start button 17e is used for instructing the CPU 7 to load a game program from the recording medium 10, and is used for other purposes.

The select button 17f is used for instructing the CPU 7 to make various selections in the game program loaded from the recording medium 10, and is used for other purposes.

The left stick 17SL and right stick 17SR are stick controllers, which have substantially the same configuration as a so-called joystick. The stick controllers have upright sticks. The sticks are configured to be able to tilt in all direction 360°, including the forward, rearward, right, and left directions from the upright position about the center of the point of support. The left stick 17SL and right stick 17SR send to the CPU 7 the values of the x and y coordinates as an operation signal using the upright position as the origin by way of the operation information interface circuit 18 and interface circuit 19 in accordance with the tilt direction and tilt angle of the stick.

The first button 17a, second button 17b, third button 17c, fourth button 17d, L1 button L1, L2 button L2, R1 button 17R1, and R2 button 17R2 are assigned various functions in accordance with the game program loaded from the recording medium 10.

The buttons and keys of the controller 17, excluding the left stick 17SL and the right stick 17SR, are each on/off switches that are on when pressed from the neutral position by external pressing force and are off when the pressing force is released and the button or key returns to its neutral position.

The overall operation of the home video game apparatus having the above configuration will be described below. When the power switch (not shown) is turned on and power is fed to the game system 1, the CPU 7 reads image data, audio data, and program data from the recording medium 10 on the basis of the operating system stored in the recording medium 10. All or a part of the image data, audio data, and program data read is stored in the RAM 12. The CPU 7 issues commands for outputting image data and audio data stored in the RAM 12 as an image or audio output to the television monitor 20 or the speaker 13, on the basis of the program data stored in the RAM 12.

In the case of image data, at first, the signal processor 8 performs position and light source calculations, and the like, of a character, in a 3D space on the basis of commands from the CPU 7. Next, the image processor 9 performs a process such as writing to the RAM 12, based on the calculation results of the signal processor 8, image data that is to be drawn. Image data written to the RAM 12 is fed to the D/A converter 22 through the interface circuit 21. At this point, the image data is converted to an analog image signal in the D/A converter 22. The image data is fed to the television monitor 20 and displayed as an image.

In the case of audio data, first the signal processor 8 generates and processes audio data on the basis of commands from the CPU 7. In this case, audio data is processed, and processing includes, e.g., pitch conversion, noise addition, envelope setting, level setting, and reverberation addition. Next, the audio data is outputted from the signal processor 8 and fed to the D/A converter 15 through the interface circuit 16. At this point, the audio data is converted to an analog audio signal. The audio data is outputted as audio from the speaker 13 through the amplifier circuit 14.

### Overview of Various Processes in the Game Apparatus

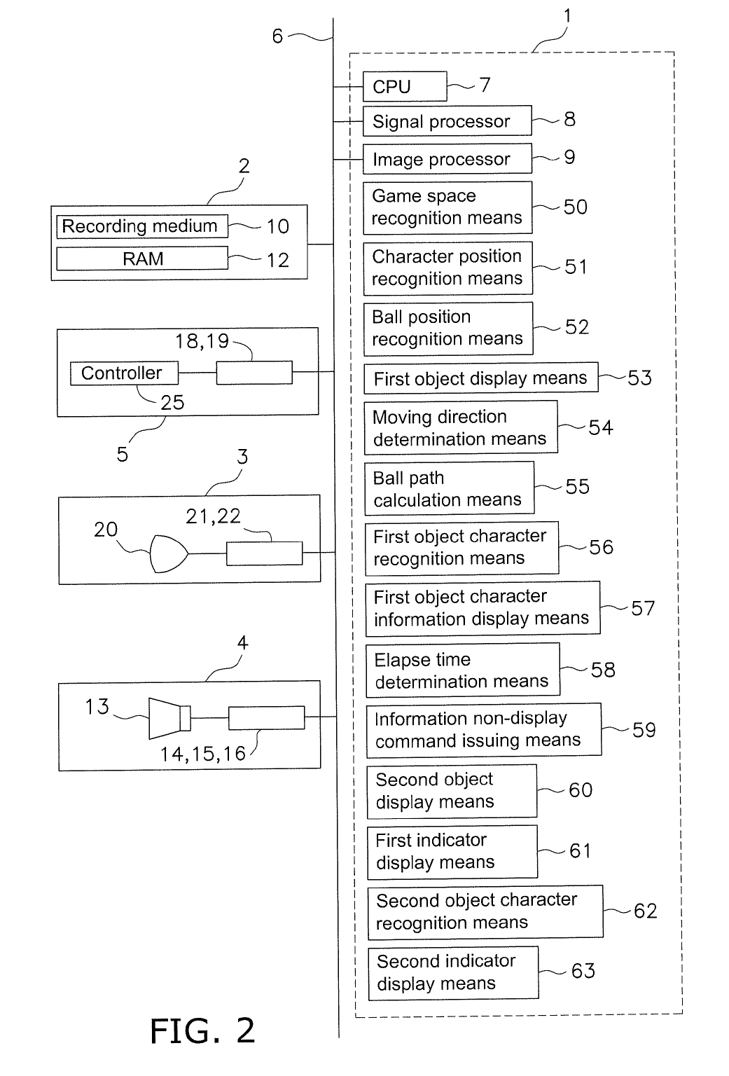

The game executed in the present game machine 1 is, for example, a baseball game. This game machine 1 is able to execute a game in which characters and a ball are displayed on the television monitor 20. FIG. 2 is a function block diagram used for describing functions that play principal roles in the present invention.

A game space recognition means includes a function by which a game space is recognized by the CPU 7.

With this means, the game space is recognized by the CPU 7. With this means, for instance, the game space is set in a 3D orthogonal coordinate system, and the 3D game space is recognized by the CPU 7. In addition, with this means, for instance, various basic coordinate data, necessary for executing a baseball game, of a foul line for distinguishing between a fair region and a foul region, each base position, a fence line for distinguishing between a fair region and a home run region, and the like are provided from the recording medium 10 to the RAM 12. Furthermore, the basic coordinate data stored in the RAM 12 is recognized by the CPU 7.

A character position recognition means includes a function by which the positions of a plurality of characters arranged in the game space are recognized by the CPU 7.

With this means, the positions of a plurality of characters arranged in the game space are recognized by the CPU 7. With this means, for instance, positional coordinate data for arranging a pitcher character, a catcher character, a fielder character, a batter character, and other characters in the game space is recognized by the CPU 7. This positional coordinate data is prepared for each character. The positional coordinate data of each character as the initial data is provided from the recording medium 10 to the RAM 12. The positional coordinate data stored in the RAM 12 is recognized by the CPU 7. In addition, positional coordinate data in the case that a character moved during the execution of a game is continuously stored in the RAM 12, and the positional coordinate data stored in the RAM 12 is recognized by the CPU 7.

A ball position recognition means includes a function by which the position of a ball that moves in the game space is recognized by the CPU 7.

With this means, the position of the ball that moves in the game space is recognized by the CPU 7. With this means, for instance, the positional coordinate data showing the position of the ball character released from the pitcher character, the positional coordinate data showing the position of the ball character hit back by the batter character, and the like are continuously stored in the RAM 12 during the time that the ball character is moving, and the positional coordinate data stored in the RAM 12 is recognized by the CPU 7.

A first object display means includes a function by which the ball and at least any one of the plurality of characters when the game space is viewed from a first direction (from a first view point) are displayed on the television monitor 20 in the position of the ball and position of the characters that are recognized by the CPU 7.

With this means, the ball and at least any of one of the plurality of characters when the game space is viewed from a first direction are displayed on the television monitor 20 in the position of the ball and the positions of the characters that are recognized by the CPU 7. With this means, for instance, the pitcher character, batter character, fielder character, and the ball character when looking at the game space from the catcher direction are displayed on the television monitor 20 in positions specified by the positional coordinate data of each of the characters recognized by the CPU 7, using the image data of each of the characters. Here, the image data of each character is loaded from the recording medium 10 to the RAM 12 during the time the game program is loaded, and stored in the RAM 12. In addition, in this embodiment, the screen when looking at the game space from the catcher direction may be described as the offense screen.

A moving direction determination means includes a function by which whether or not the moving direction of the ball has changed in accordance with a movement of a character displayed on the television monitor 20 is judged by the CPU 7.

With this means, whether or not the moving direction of the ball has changed during a movement of a character displayed on the television monitor 20 is judged by the CPU 7. With this means, for instance, whether or not the moving direction of the ball character has changed during a swing movement of the batter character displayed on the television monitor 20 is judged by the CPU 7. Here, the judgment of whether or not the moving direction of the ball character has changed, for example, whether or not an object for changing the moving direction of a moving object e.g., a meet cursor for changing the moving direction of the ball character, and the moving object that is moving e.g., the ball character that is moving overlap each other is judged by the CPU 7. More specifically, whether or not the ball character is hit by the bat object in accordance with a swing movement of the batter character, in other words, whether or not at least one coordinate data within the region of the meet cursor during the movement of the batter character and at least one of the coordinate data within the display region of the ball character match is judged by the CPU 7.

In addition, here, if the operation input unit 5, for example the controller 17 is operated, the center position of the meet cursor continuously moves in the game space, and the center position of the meet cursor after it is moved is regulated in the game space. Specifically, when the operation input unit 5, for example the controller 17 is operated, an input signal from the controller 17 is recognized by the CPU 7. Furthermore, based on the input signal recognized by the CPU 7, a command by which the positional coordinate data for regulating the center position of the meet cursor in the game space is continuously moved is issued from the CPU 7. As a result, the center position of the meet cursor moves, and the positional coordinate data of the meet cursor after the movement is recognized by the CPU 7. In this manner, the center position of the meet cursor is regulated in the game space by having the positional coordinate data of the meet cursor recognized by the CPU 7. In this way, if the center position of the meet cursor is regulated in the game space, coordinate data within the region of the meet cursor corresponding to the region of the meet cursor is recognized by the CPU 7, with the center position of the meet cursor as the reference point. In addition, a boundary for specifying the coordinate data within the region of the meet cursor is specified in advance in the game program.

A ball path calculation means includes a function by which the path of the ball is calculated by the CPU 7 in the case that the CPU 7 judged that the moving direction of the ball has changed due to a movement of a character displayed on the television monitor 20.

With this means, in the case that the CPU 7 judged that the moving direction of the ball has changed due to a movement of a character displayed on the television monitor 20, the path (trajectory) of the ball character is calculated by the CPU 7. With this means, for instance, if the CPU 7 judged that the moving direction of the ball character has changed due to the movement of the batter character displayed on the television monitor 20, the path of the ball character is calculated by the CPU 7. More specifically, in the case that the CPU 7 judged that at least one coordinate data within the region of the meet cursor during the movement of the batter character, and at least one coordinate data within the display range of the ball character matched, the path of the ball character is calculated by the CPU 7.

The calculation of the path of the ball character is performed as follows. First, mass data corresponding to the mass of the ball character, air resistance data corresponding to the air resistance of the ball, the positional coordinate data showing the center position of the meet cursor that is the reference point for the changes in the moving direction of the ball character, an initial speed data corresponding to the initial speed of the ball character in the center position of the meet cursor when the moving direction of the ball character has changed, and release angle data corresponding to the release angle of the ball character from the center position of the meet cursor when the moving direction of the ball character has changed are recognized by the CPU 7. Next, the path of the ball character is calculated with these various data as the calculation conditions, based on path equations of the ball (m(d2x/dt2)=−r(dx/dt), m(d2z/dt2)=−mg−r(dz/dt)). More specifically, in the game program, the above described path equations of the ball are described in a discretized state, and various data shown above are substituted in this discretized path equations. By having the CPU 7 execute the calculation of the path equations with various data substituted in this manner, progressed temporally at a unit time (dt) at a time, it is possible to calculate the positional coordinate, in other words, positional coordinate data of the ball character in each time instant. By doing so, the path of the ball character is calculated.

A first object character recognition means includes a function by which a character near the path of the ball character determined by the changed moving direction of the ball character is recognized by the CPU 7 as a first object character, in the case that the CPU 7 judged that the moving direction of the ball character has changed due to a movement of a character.

With this means, in the case that the CPU 7 judged that the moving direction of the ball has changed due to a movement of a character, the character near the path of the ball determined by the changed moving direction of the ball is recognized by the CPU 7 as the first object character. More specifically, in the case that the CPU 7 judged that at least one coordinate data within the region of the meet cursor during the movement of the batter character, and at least one coordinate data within the display range of the ball character matched each other, the character near the path of the ball character determined by the changed moving direction of the ball character is recognized by the CPU 7 as the first object character. More specifically, in the case that the CPU 7 judged that at least one coordinate data within the region of the meet cursor during the movement of the batter character and at least one coordinate data within the display range of the ball character matched, the distance between the positional coordinate of each character and the path calculated by the CPU 7 is calculated by the CPU 7, and the character in a position with the shortest distance out of the distances calculated is recognized by the CPU 7 as the first object character.

A first object character information display means includes a function for displaying information corresponding to the first object character on the television monitor 20. In addition, information shown here includes a first term for differentiating the plurality of characters from each other, and a second term for differentiating the roles of each of the plurality of characters.

With this means, information corresponding to the first object character is displayed on the television monitor 20. With this means, information corresponding to the first object character, e.g., first term for differentiating the plurality of characters from each other and second term for differentiating the roles of each of the plurality of characters, is displayed on the television monitor 20. Information corresponding to the first object character is displayed on the television monitor 20 based on first object character information data. First object character information data includes first term image data for expressing the first term. e.g., player name or number on the back as an image, and second term image data for expressing the second term, e.g., fielding position name as an image. The first term image data and second term image data are loaded from the recording medium 10 to the RAM 12 when the game program is loaded, and stored in the RAM 12. Furthermore, the corresponding relationship between the first object character, and the first term image data and second term image data stored in the RAM 12 is specified in advance in the game program. In addition, in this embodiment, an example is shown of a case that a player name is displayed on the television monitor 20 using the first term image data for expressing the player name as an image.

An elapse time determination means includes a function by which whether or not a predetermined time has passed from the time that the moving direction of the ball character is judged by the CPU 7 to have been changed due to a movement of a character is judged by the CPU 7.

With this means, whether or not a predetermined time has passed from the time that the CPU 7 judged that the moving direction of the ball has changed due to a movement of a character is judged by the CPU 7. With this means, for instance, whether or not a predetermined time, e.g., 1 second has passed from the time that the CPU 7 judged that at least one coordinate data within the region of the meet cursor during the movement of the batter character and at least one coordinate data within the display range of the ball character matched is judged by the CPU 7.

An information non-display command issuing means includes a function by which a command for hiding information displayed on the television monitor 20 is issued by the CPU 7 if the CPU 7 judged that a predetermined time has passed from the time that the CPU 7 judged that the moving direction of the ball character has changed due to a movement of a character.

With this means, if the CPU 7 judged that a predetermined time has passed from the time that the moving direction of the ball is judged by the CPU 7 to have been changed due to a movement of a character, a command for hiding the information displayed on the television monitor 20 is issued from the CPU 7. With this means, for instance, if the CPU 7 judged that a predetermined time, e.g., 1 second has passed from the time that the CPU 7 judged that at least one coordinate data within the region of the meet cursor during the movement of the batter character and at least one coordinate data within the display range of the ball character matched, a command for hiding the information displayed on the television monitor 20 is issued from the CPU 7. As a result, the information displayed on the television monitor 20 is not displayed on the television monitor 20.

A second object display means includes a function for displaying the ball character and at least any of one of the plurality of characters when the game space is viewed from a second direction (from a second view point), in the position of the ball character and the positions of the characters recognized by the CPU 7 on the television monitor 20, in the case that the CPU 7 judged that a predetermined time has passed. In addition, the second object display means includes a function for displaying the ball character on the television monitor 20 on the position of the ball character recognized by the CPU 7 when the CPU 7 judged that the moving direction of the ball character has changed.

With this means, if the CPU 7 judged that a predetermined time has passed from the time that the CPU 7 judged that the moving direction of the ball has changed due to a movement of a character, the ball character and at least any of one of the plurality of characters when the game space is viewed from a second direction are displayed on the television monitor 20 in the position of the ball character and the positions of the characters recognized by the CPU 7. Specifically, if the CPU 7 judged that a predetermined time has passed from the time that the CPU 7 judged that the moving direction of the ball character has changed due to a movement of a character, the ball character and at least any of one of the plurality of characters when the game space is viewed from a second direction are displayed on the television monitor 20 in the position of the ball character and the positions of the characters recognized by the CPU 7 when the CPU 7 judged that the moving direction of the ball character has changed.

With this means, for instance, if the CPU 7 judged that a predetermined time has passed from the time that the CPU 7 judged that at least one coordinate data within the region of the meet cursor during the movement of the batter character and at least one coordinate data within the display range of the ball character matched, the pitcher character, catcher character, batter character, fielder character, and the ball character when looking down from above at the game space are displayed on the television monitor 20 in the positions of each of the characters and the position of the ball character recognized by the CPU 7 when the CPU 7 judged that at least one coordinate data within the region of the meet cursor during the movement of the batter character and at least one coordinate data within the display range of the ball character matched, using the image data of each character. Here, the positions of each of the characters are specified by the positional coordinate data of each of the characters, and the position of the ball character is specified by the positional coordinate data of the ball character. Here, the image data of each character is loaded from the recording medium 10 to the RAM 12 when the game program is loaded, and stored in the RAM 12. Furthermore, in this embodiment, the screen when looking down from above at the game space, in other words, the screen when looking at the game space from up in the air may be described as the fielding screen.

A first indicator display means includes a function for displaying an indicator for informing about the first object character on the television monitor 20.

With this means, the indicator for informing about the first object character is displayed on the television monitor 20. With this means, the indicator for informing about the first object character, for instance a triangular symbol pointing at the first object character is displayed on the television monitor 20 above the first object character using triangular symbol image data. The triangular symbol image data is loaded from the recording medium 10 to the RAM 12 when the game program is loaded, and stored in the RAM 12. The triangular symbol for pointing at the first object character is displayed on the television monitor 20 above the first object character, by using the triangular symbol image data stored in the RAM 12.

A second object character recognition means includes a function by which a character different from the first object character is recognized by the CPU 7 as the second object character, based on an input signal from the operation input unit 5, e.g., the controller 17.

With this means, a character different from the first object character is recognized by the CPU 7 as the second object character based on an input signal from the controller 17. With this means, for instance, in the state that the first object character is recognized by the CPU 7, if the controller 17 is operated, the input signal from the controller 17 is recognized by the CPU 7. Furthermore, based on the input signal recognized by the CPU 7, the character positioned in the direction indicated by the controller 17 is recognized by the CPU 7 as the second object character.

A second indicator display means includes a function for displaying an indicator for informing about a second object character on the television monitor 20.

With this means, the indicator for informing about the second object character is displayed on the television monitor 20. With this means, for instance, an indicator for informing about the second object character, e.g., a triangular symbol for pointing at the second object character is displayed on the television monitor 20 above the second object character using triangular symbol image data. This triangular symbol image data is loaded from the recording medium 10 to the RAM 12 when the game program is loaded, and stored in the RAM 12. The triangular symbol for pointing at the second object character is displayed on the television monitor 20 above the second object character, by using the triangular symbol image data stored in the RAM 12.

In addition, in this embodiment, the screen when looking at the game space from the first direction is generated by having the CPU 7 execute a process of converting the 3D game space into the 2D game space, with a first viewpoint position of the game space, e.g., position of the catcher character as the reference. In the same way, a screen when looking at the game space from the second direction is generated by having the CPU 7 execute a process of converting the 3D game space into the 2D game space, with a second viewpoint position of the game space, e.g., position above the pitcher character as the reference.

### Process Flow and Description of a Selection Player Preliminarily Informing System in a Baseball Game

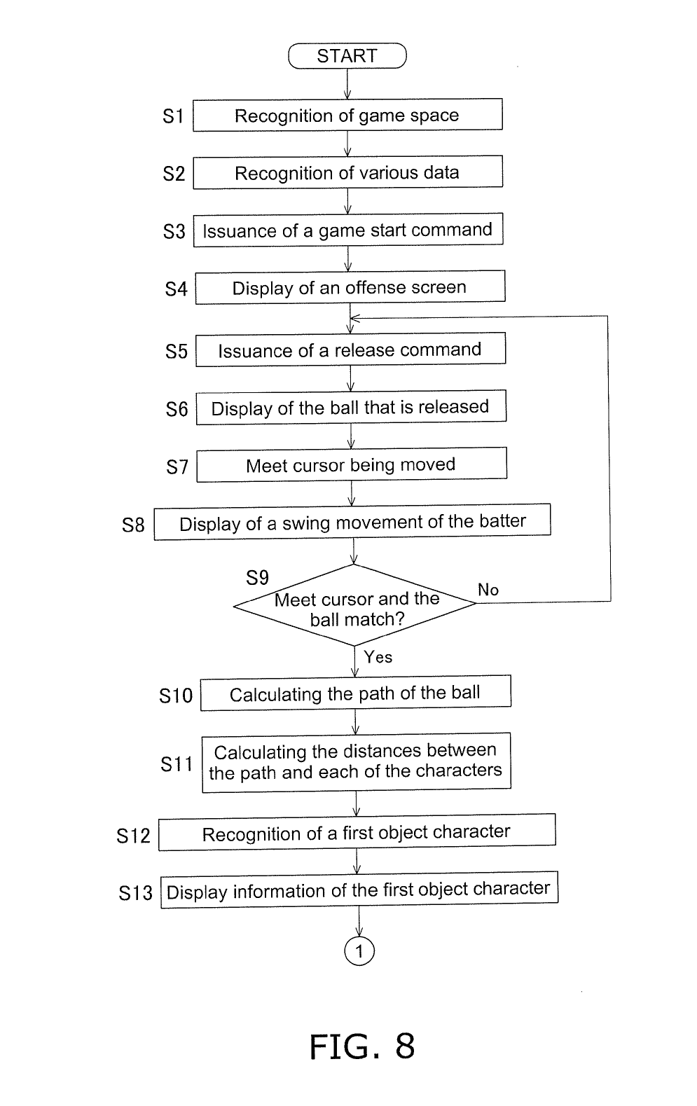

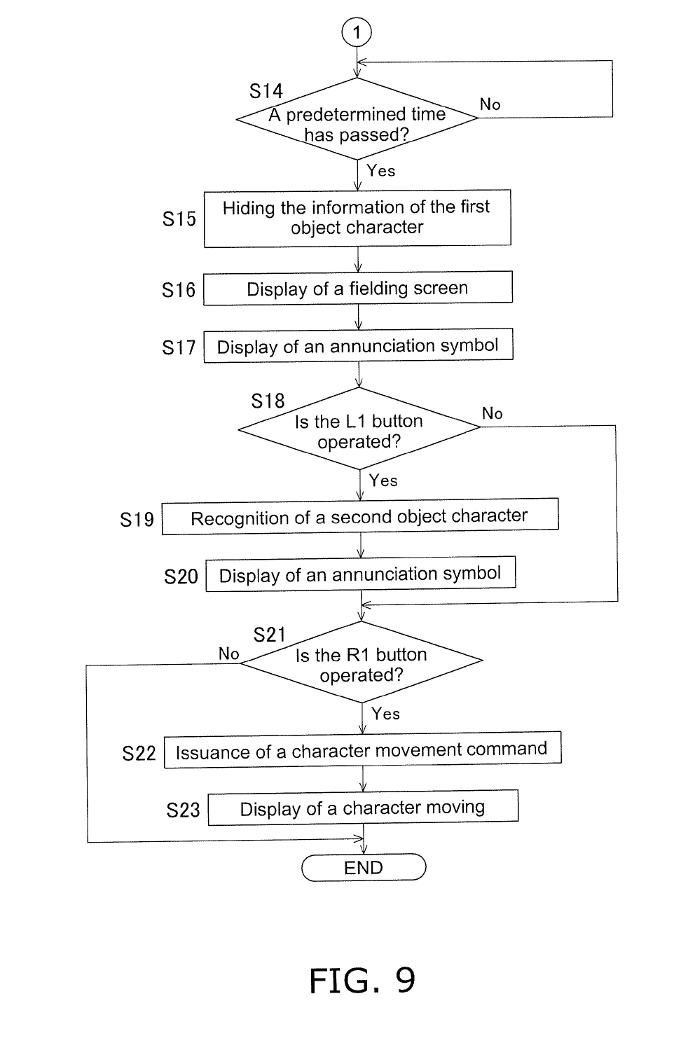

Next, specific content of a selection player preliminarily informing system in a baseball game will be described. In addition, the flow related to the selection player preliminarily informing system shown in FIGS. 8 and 9 will also be described at the same time.

Here, a case that a character on the fielding side is operated by the player, and a batting character is operated by the opponent player is described as an example.

First, when the baseball game program is loaded in the game apparatus, a 3D game space in which a baseball game is executed is recognized by the CPU 7 (S1). At this time, the basic coordinate data specified in this game space is recognized by the CPU 7. Then, the positional coordinate data of each character arranged in this game space is recognized by the CPU 7. Image data of each character is recognized by the CPU 7 (S2). Here, each data recognized by the CPU 7 is loaded from the recording medium 10 to the RAM 12 when the game program is loaded, and stored in the RAM 12.

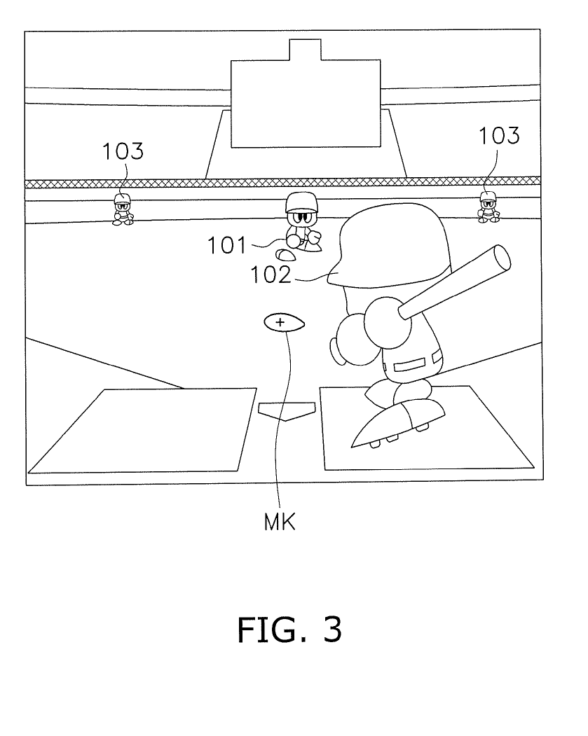

Next, if a game start command is issued form the CPU 7 (S3), as shown in FIG. 3, the offense screen is displayed on the television monitor 20 (S4). The offense screen is a screen when the game space is viewed from the catcher direction. In this offense screen, a pitcher character 101, batter character 102, and fielder characters 103 are displayed on the television monitor 20 in the positions specified by the positional coordinate data of each of the characters recognized by the CPU 7, using the image data of each of the characters.

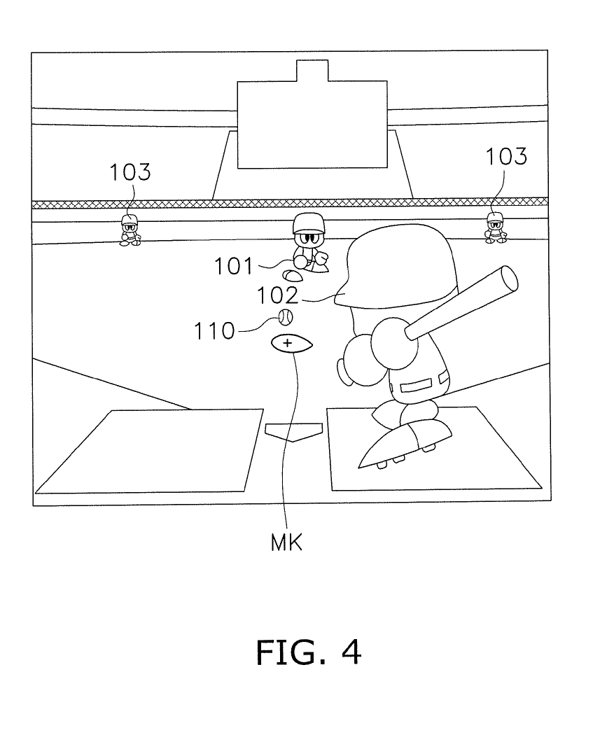

Next, through the controller 17 being operated, the pitching course and the type of pitch of the pitcher character 101 is recognized by the CPU 7, and when a release command of the ball is issued from the CPU 7 to the pitcher character 101 (S5), the moving position, in other words, the positional coordinate data of the ball character 110 that moves by the type of pitch recognized by the CPU 7 and in the pitching course recognized by the CPU 7 is continuously stored in the RAM 12. Then, the positional coordinate data stored in the RAM 12 is recognized by the CPU 7. As a result, as shown in FIG. 4, the state that the ball character 110 released from the pitcher character 101 moving by the type of pitch recognized by the CPU 7 and in the pitching course recognized by the CPU 7 is displayed on the television monitor 20 (S6) based on the positional coordinate data of the ball character recognized by the CPU 7.

Next, in the state that the released ball character 110 is displayed on the television monitor 20, if the cross-shape buttons of the up-direction key 17U, down-direction key 17D, left-direction key 17L, or the right-direction key 17R of the controller 17 is operated by the opponent player, based on the input signal from the controller 17, a cursor moving command for moving the meet cursor MK in the operation direction is issued from the CPU 7. As a result, the positional coordinate data showing the center position (shown by a cross-shape symbol in the figure) of the meet cursor MK that moves in the operation direction according to the number of times that each key is pressed is recognized by the CPU 7. At this time, coordinate data within the region of the meet cursor MK corresponding to the region of the meet cursor MK, including the positional coordinate data of the meet cursor MK is recognized by the CPU 7. As a result, the state that the meet cursor MK moving in the operation direction according to the number of times that each key is pressed is displayed on the television monitor 20 based on the positional coordinate data of the meet cursor MK (S7). Then, if the third button 17c of the controller 17 is operated by the opponent player, based on this input signal from the controller 17, a swing start command to have the batter character 102 start a swing movement is issued from the CPU 7. As a result, the state that the batter character 102 is performing a swing movement is displayed on the television monitor 20 (S8).

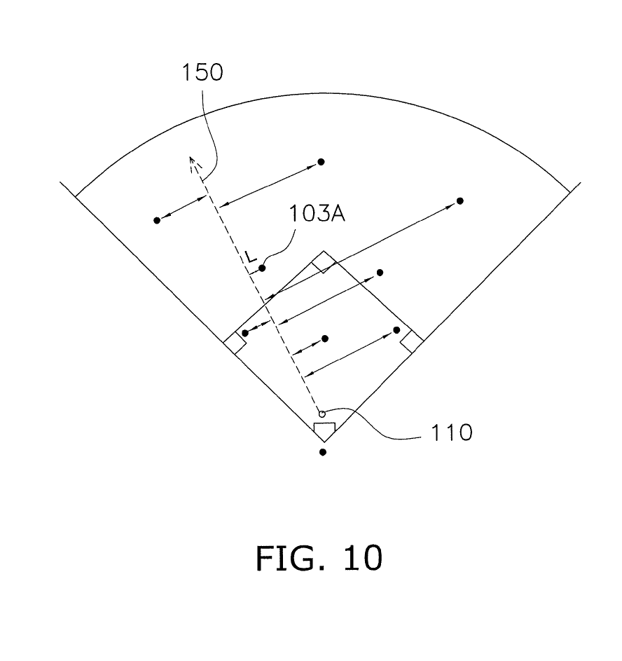

Next, whether or not at least one coordinate data within the region of the meet cursor MK during the movement of the batter character 102 and at least one coordinate data within the display range of the ball character 110 match is judged by the CPU 7 (S9). Then, if the CPU 7 judged that at least one coordinate data within the region of the meet cursor MK and at least one coordinate data within the display range of the ball character 110 matched (Yes in S9), as shown in FIG. 10, the path 150 of the ball character 110 is calculated by the CPU 7 based on the path equations (S10). Then, the positional coordinate data of the ball character 110 that moves in the path calculated by the CPU 7 is recognized by the CPU 7. And, the distances between the path and each of the characters (shown by arrows in the figure) are calculated by the CPU 7 (S11) based on the positional coordinate of the ball character 110 that is on the path and the positional coordinates of each of the characters. The distances correspond to distances of straight lines that connect the positional coordinates of each of the characters and the positional coordinates of the ball character 110 nearest to the foot of the perpendicular lines when drawing perpendicular lines to the path 150 from the positional coordinates of each of the characters. The character in a position with the shortest distance L out of the distances calculated in this manner is recognized by the CPU 7, and this character is recognized by the CPU 7 as the first object character (S12). Here, the character positioned in a nearest position from the path 150 is a character that is a shortstop, and thus, the shortstop character 103A is recognized by the CPU 7 as the first object character.

In addition, if the CPU 7 judged that at least one coordinate data within the region of the meet cursor MK and at least one coordinate data within the display range of the ball character 110 do not match (No in S9), the CPU 7 is in an input signal waiting state, so that an input signal from the controller 17 for setting the pitching course and the type of pitch can be received.

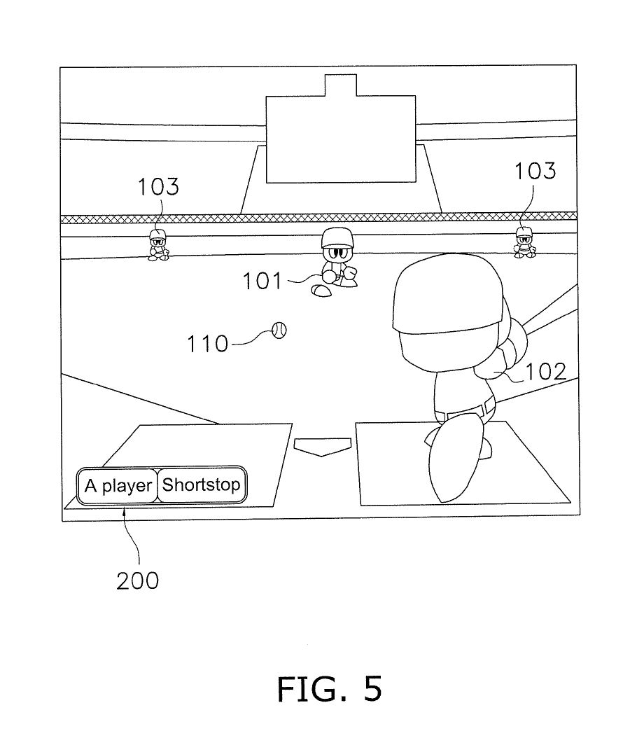

Next, information corresponding to the first object character, for instance name and the fielding position name 200 of the shortstop character 103A is displayed on the television monitor 20 (S13) based on shortstop character information data. Here, as shown in FIG. 5, the name and fielding position name 200 of the shortstop character 103A are displayed on the lower left portion on the television monitor 20 based on the shortstop character information data.

Next, whether or not a predetermined time, for example, 1 second has passed from the time that the CPU 7 judged that at least one coordinate data within the region of the meet cursor MK and at least one coordinate data within the display range of the ball character 110 matched is judged by the CPU 7 (S14). Then, if the CPU 7 judged that a predetermined time, for instance 1 second has passed (Yes in S14), a command for hiding the name and the fielding position name 200 of the shortstop character 103A displayed on the television monitor 20 is issued from the CPU 7. As a result, the name and the fielding position name 200 of the shortstop character 103A are not displayed on the television monitor 20 (S15). In other words, when the screen is changed to the fielding screen to be shown next, the name and the fielding position name 200 of the shortstop character 103A are not displayed on the television monitor 20.

Furthermore, here, by executing the information non-display command issuing means, the name and the fielding position name 200 of the shortstop character 103A are not displayed when the screen is changed, but it is not always necessary to execute the information non-display command issuing means. For instance, if a game apparatus does not include an information non-display command issuing means, or if information non-display command issuing means is not executed, the name and the fielding position name 200 of the shortstop character 103A will be displayed on the next screen, in other words, the fielding screen.

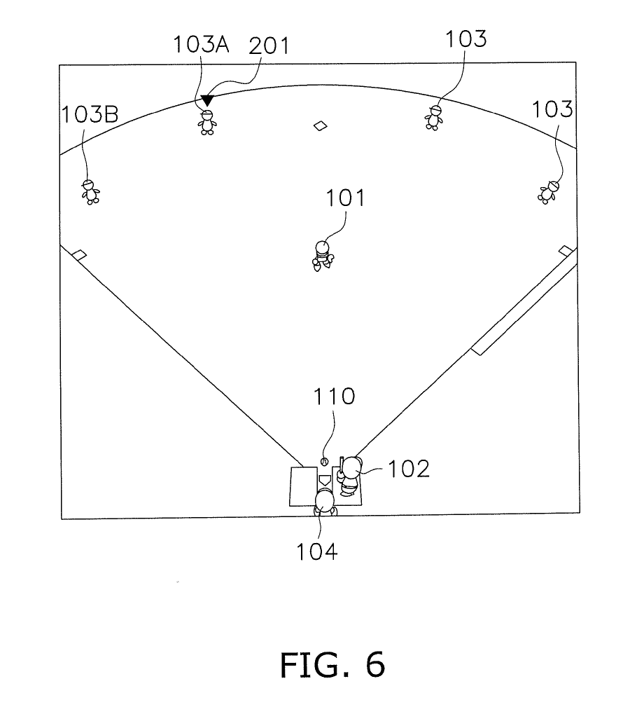

Next, if the CPU 7 judged that a predetermined time, for instance 1 second has passed from the time that the CPU 7 judged that at least one coordinate data within the region of the meet cursor MK and at least one coordinate data within the display range of the ball character 110 matched, the fielding screen is displayed on the television monitor 20 (S16). The fielding screen is a screen when looking down at the game space from above. In this fielding screen, as shown in FIG. 6, the pitcher character 101, catcher character 104, batter character 102, fielder characters 103, and the ball character 110 are displayed on the television monitor 20 in the positions of each of the characters and the position of the ball character 110 at the time that the CPU 7 judged that at least one coordinate data within the region of the meet cursor MK and at least one coordinate data within the display range of the ball character 110 matched. Then, an indicator, for example, a triangular symbol 201 for informing the player of the shortstop character 103A is displayed on the television monitor 20 above the shortstop character 103A (S17) using triangular symbol image data.

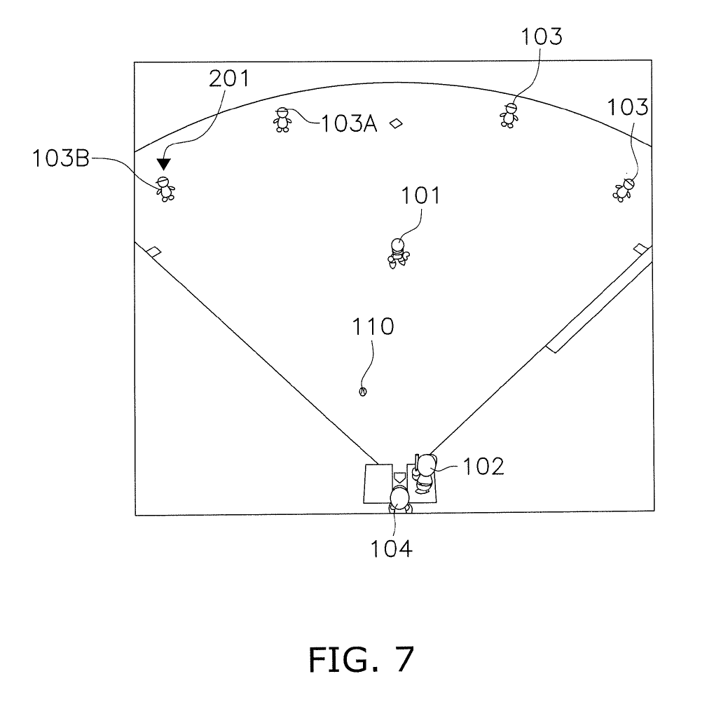

Next, whether or not the operation input unit 5, for instance the L1 button L1 of the controller 17 is operated by the player is judged by the CPU 7 (S18). In other words, whether or not an operation signal of the L1 button L1 of the controller 17 is recognized by the CPU 7 is judged by the CPU 7. Then, if the CPU 7 judged that an operation signal of the L1 button L1 of the controller 17 is recognized by the CPU 7 (Yes in S18), if the cross-shape buttons of the up-direction key 17U, down-direction key 17D, left-direction key 17L, or the right-direction key 17R of the controller 17 is operated, based on this input signal from the controller 17, the fielder character 103 nearby in the operation direction of the controller 17 is recognized by the CPU 7 as the second object character (S19). For example, if the left-direction key 17L of the cross-shape buttons is operated by the player in the state that the L1 button L1 of the controller 17 is pressed, the state that the shortstop character 103A being recognized by the CPU 7 is released, and a third baseman character 103B is recognized by the CPU 7 as the second object character. Then, as shown in FIG. 7, the triangular symbol 201 displayed above the shortstop character 103A disappears, and the triangular symbol 201 is newly displayed above the third baseman character 103B (S20).

Next, whether or not the operation input unit 5, for example the R1 button R1 of the controller 17 is operated by the player is judged by the CPU 7 (S21). In other words, whether or not an operation signal of the R1 button of the controller 17 is recognized by the CPU 7 is judged by the CPU 7. Then, if the CPU 7 judged that an operation signal of the R1 button of the controller 17 is recognized by the CPU 7 (Yes in S21), and if the cross-shape buttons of the up-direction key 17U, down-direction key 17D, left-direction key 17L, or the right-direction key 17R of the controller 17 is operated, based on this input signal from the controller 17, a movement command for moving the second object character, e.g., the third baseman character 103B in the operation direction of the controller 17 is issued from the CPU 7 (S22). As a result, the state that the third baseman character 103B, along with the triangular symbol 201, moving in the operation direction of the controller 17 is displayed on the television monitor 20 (S23).

On the other hand, if the CPU 7 judged that an operation signal of the L1 button L1 of the controller 17 is not recognized by the CPU 7 (No in S18), whether or not the operation input unit 5, for instance the R1 button R1 of the controller 17 is operated by the player is judged by the CPU 7 (S21). In other words, whether or not an operation signal of the R1 button of the controller 17 is recognized by the CPU 7 is judged by the CPU 7. Then, if the CPU 7 judged that an operation signal of the R1 button of the controller 17 is recognized by the CPU 7 (Yes in S21), and if the cross-shape buttons of the up-direction key 17U, down-direction key 17D, left-direction key 17L, or the right-direction key 17R of the controller 17 is operated, based on this input signal from the controller 17, a movement command for moving the first object character, for instance the shortstop character 103A in the operation direction of the controller 17 is issued from the CPU 7 (S22). As a result, the state of the shortstop character 103A, along with the triangular symbol 201 moving in the operation direction of the controller 17 is displayed on the television monitor 20 (S23).

### Other Embodiments

(a) In the above described embodiment, an example was shown of a case in which a home video game apparatus as an example of a computer in which the game program can be applied is used. However, the game apparatus is not limited to the embodiment described above, and application can also be made in the same matter to a game apparatus in which a monitor is separately configured; a game apparatus in which a monitor is integrally configured; or a personal computer, workstation, or other device that functions as a game apparatus by executing the game program.

(b) Also included in the present invention are a program that executes the game as described above, and a computer-readable recording medium on which this program is recorded. Other than a cartridge, examples of the recording medium include a computer-readable flexible disk, semiconductor memory, CD-ROM, DVD, MO, ROM cassette, and the like.

(c) In the above described embodiment, even though an example of a case that information corresponding to the first object character is displayed on the television monitor 20 is shown, the form of displaying information is not limited to that of the above described embodiment, and the following kind of a function may be added. For instance, the game apparatus may include a second object character information display means, and may display information corresponding to the second object character on the television monitor 20. Specifically, in the state that the information corresponding to the first object character is displayed on the television monitor 20 in the above described embodiment, if the cross-shape buttons of the up-direction key 17U, down-direction key 17D, left-direction key 17L, or the right-direction key 17R of the controller 17 is operated, based on this input signal from the controller 17, the fielder character 103 nearby in the operation direction of the controller 17 is recognized by the CPU 7 as the second object character. Then, information corresponding to the second object character is displayed on the television monitor 20. For instance, in the state that information corresponding to the first object character is displayed on the television monitor 20 on a batting screen, if the left-direction key 17L of the cross-shape buttons of the controller 17 is operated, information corresponding to the second object character, for instance the name and fielding position name of the third baseman character 103B is displayed on the television monitor 20 based on the third baseman character information data.

In the present invention, in the state that each character when looked from the first direction is displayed on the image display unit, if the control unit judged that the moving direction of the moving object has changed due to a movement of a character, information corresponding to a first object character near the path determined by the changed moving direction of the moving object is displayed on the image display unit. As a result, the player is able to see the information corresponding to the first object character near the path determined by the changed moving direction of the moving object on the image display unit. For this reason, the first object character near the path of the moving object, for instance, the character that is the object to be operated, can be determined beforehand based on the information corresponding to the character that is the object to be operated, and the next operation can be executed quickly and accurately. In other words, the player will be able to quickly execute a command on a character.

The terms of degree such as “substantially”, “about” and “approximately” as used herein mean a reasonable amount of deviation of the modified term such that the end result is not significantly changed. These terms should be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A computer readable medium storing a computer program for a video game in which characters and a moving object are displayed on an image display unit, the game program comprising:
code for recognizing a game space;
code for recognizing positions of the characters in the game space;
code for recognizing a position of the moving object, that moves, in the game space;
code for displaying moving object and at least one of the characters in the game space from a first view point;
code for determining whether or not a direction of the moving object is changed;
code for recognizing the closest character among the characters to a trajectory of the moving object as a first object character, if the moving direction is changed; and
code for displaying first information of the first object character.

2. The computer readable medium according to claim 1, the game program further comprising
code for determining whether or not a predetermined time is passed from when the direction of the moving object is changed; and
code for displaying the moving object and at least one of the characters in the game space from a second view point, if the predetermined time is passed.

3. The computer readable medium according to claim 2, wherein
the moving object is displayed at the position of the moving object from the second view point, if the direction of the moving object is changed.

4. The computer readable medium according to claim 1, the game program further comprising
code for recognizing one of the characters other than the first object character, as a second object character; and
code for displaying second information of the second object character.

5. The computer readable medium according to claim 1, the game program
further comprising
code for determining whether or not a predetermined time is passed from when the direction of the moving object is changed; and
code for erasing the first information, if the predetermined time is passed.

6. The computer readable medium according to claim 1, the game program further comprising
code for displaying a first indicator which shows the first object character.

7. The computer readable medium according to claim 1, the game program further comprising:
code for recognizing one of the characters other than the first object character, as a second object character; and
code for displaying a second indicator which shows the second object character.

8. The computer readable medium according to claim 1, wherein
the first information includes a first term that differentiates the first object character from the characters, and a second term that differentiates roles of the first object character from roles of the characters.

9. The computer readable medium according to claim 4, wherein
the second information includes a first term that differentiates the second object character from the characters, and a second term that differentiates roles of the second object character from roles of the characters.

10. A game apparatus of a video game in which characters and a moving object are displayed on an image display unit, the game apparatus comprising:
a game space recognition unit configured to recognize a game space;
a character position recognition unit configured to recognize positions of characters in the game space;
a moving object position recognition unit configured to recognize a position of the moving object in the game space;
a first object display unit configured to display the moving object and at least one of the characters in the game space from a view point;
a moving direction determination unit configured to determine whether or not a direction of the moving object is changed;
a first object character recognition unit configured to recognize the closest character among the chanters to a trajectory of the moving object as a object character, if the direction of the moving object is changed; and
a first object character information display unit configured to display information of the object character.

11. A method for controlling a video game in which characters and a moving object are displayed on an image display unit, the method comprising:
recognizing a game space;
recognizing positions of the characters in the game space;
recognizing a position of the moving object, that moves, in the game space;
displaying moving object and at least one of the characters in the game space from a view point;
determining whether or not a direction of the moving object is changed;
recognizing the closest character among the characters to a trajectory of the moving object as an object character, if the moving direction is changed; and
displaying information of the object character.
